(19) United States
(12) Patent Application Publication
(10) Pub. No.: US 2018/0281647 A1
(43) Pub. Date: Oct. 4, 2018

(54) VEHICLE SEAT COMPONENT AND METHOD OF MANUFACTURING THE SAME

(71) Applicant: TOYOTA BOSHOKU KABUSHIKI KAISHA, Aichi-ken (JP)

(72) Inventors: Yoshiyuki MURATA, Aichi-ken (JP); Tetsuo HAYASHIDA, Aichi-ken (JP); Mitsuyoshi OCHIAI, Aichi-ken (JP); Shota MATSUSHITA, Aichi-ken (JP); Naoto SHIMOTOI, Aichi-ken (JP)

(73) Assignee: TOYOTA BOSHOKU KABUSHIKI KAISHA, Aichi-ken (JP)

(21) Appl. No.: 15/936,821

(22) Filed: Mar. 27, 2018

(30) Foreign Application Priority Data
Mar. 29, 2017 (JP) 2017-064803

(51) Int. Cl. B60N 2/70; B60N 2/58; B29C 44/02; A47C 7/18; B29C 44/12; B29C 44/14

(52) U.S. Cl. CPC B60N 2/7017; B60N 2/5816; B29C 44/145; A47C 7/18; B29C 44/1214; B29C 44/025

(57) ABSTRACT

A vehicle seat component includes: a seat pad having a seating portion and an outer portion; and a seat cover serving as an outer cover material being bonded to the seat pad, wherein at least a part of the seat cover at which the seat cover is bonded to the outer portion, is provided with an extension part that extends from an end of the outer portion at a side opposite to the seating portion, wherein the outer portion is provided with a groove at a rear surface part of the seat pad, the groove extending along the end and having a bottom surface at a position closer to the seating portion with respect to the rear surface part, and wherein at least a part of the extension part is integrally bonded to a wall surface of the groove by the integral foam-molding.

### CROSS-REFERENCE TO RELATED APPLICATION

This application claims priorities from Japanese Patent Application No. 2017-064803 filed on Mar. 29, 2017, the entire subject matters of which is incorporated herein by reference.

### TECHNICAL FIELD

The present disclosure relates to a vehicle seat component and a method of manufacturing the same. Specifically, the present disclosure relates to a vehicle seat component in which an outer cover and a seat pad are integrally foam-molded, and a method of manufacturing the same.

### BACKGROUND

In the related art, there is known a vehicle seat component in which an outer cover and a seat pad are integrally foam-molded. In a vehicle seat component disclosed in JP-UM-A-H03-058199, in a seating portion which is a sitting surface of the seat pad and an outer portion which is a surrounding part, the outer cover and the seat pad are integrally bonded in a planar fashion by integrally foam-molding the seat pad.

As the vehicle seat component is disclosed in JP-UM-A-H03-058199, when the outer cover and the seat pad are integrally bonded in the planar fashion in the seating portion of the seat pad and the outer portion by integrally foam-molding the seat pad, the terminal of the outer cover is usually pulled in the rear surface of the seat pad, and is fixed by bonding, tacking, or the like. Herein, when the terminal of the outer cover is fixed to the rear surface of the seat pad by the bonding, tacking, or the like, the terminal of the seat pad is deformed due to a tensile force applied from the outer cover, and thereby causing abutting on other components and degradation in outer appearance in some cases.

### SUMMARY

The present disclosure is made in consideration of the above-mentioned circumstances, and one of objects of the present disclosure is to provide a vehicle seat component and a method of manufacturing the vehicle seat component in which an outer cover and a seat pad are integrally foam-molded and a terminal of the outer cover is fixed to the seat pad with good appearance.

According to an illustrative embodiment of the present disclosure, there is provided a vehicle seat component including: a seat pad serving as a cushion material of a seat cushion or a seat back of a vehicle seat, the seat pad having a seating portion which receives a load of an occupant and an outer portion which surrounds the seating portion; and a seat cover serving as an outer cover material being bonded to the seat pad in a planar fashion at the seating portion and the outer portion of the seat pad by integral foam-molding. At least a part of the seat cover at which the seat cover is bonded to the outer portion, is provided with an extension part that extends from an end of the outer portion at a side opposite to the seating portion. The outer portion is provided with a groove at a rear surface part of the seat pad, the groove extending along the end and having a bottom surface at a position closer to the seating portion with respect to the rear surface part. At least a part of the extension part is integrally bonded to a wall surface of the groove by the integral foam-molding.

### BRIEF DESCRIPTION OF THE DRAWINGS

In the accompanying drawings:

FIG. 1 is a top view of a seat component according to an embodiment of the present disclosure when viewed from the upper side;

FIG. 2 is a cross-sectional view taken along line II-II in FIG. 1, illustrating the seat component together with a cushion frame;

FIG. 3 is a cross-sectional view taken along line III-III in FIG. 1, illustrating the seat component together with the cushion frame and a slide rail;

FIG. 4 is a cross-sectional view schematically illustrating part of a foaming mold;

FIG. 5 is a cross-sectional view schematically illustrating a state where a cushion cover is set on part of the foaming mold; and

FIG. 6 is a cross-sectional view schematically illustrating a state where the vehicle seat component in the embodiment is integrally foam-molded using an upper mold and a lower mold, illustrating part of the corresponding part of FIG. 3.

### DETAILED DESCRIPTION

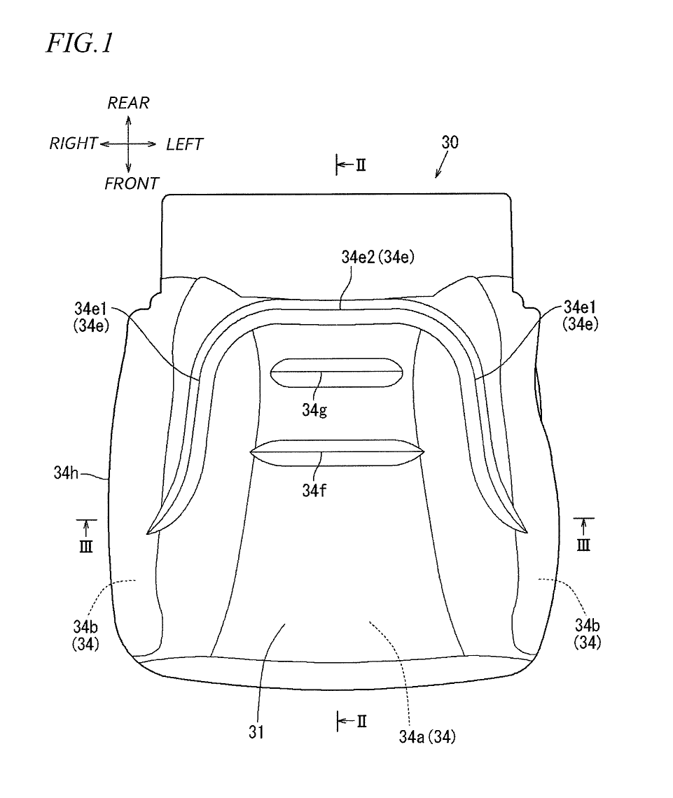

FIGS. 1 to 3 illustrate an embodiment according to the present disclosure. This embodiment is described about a seat component 30 of a seat cushion 10 of a vehicle seat. In the drawings, arrows indicate directions of a vehicle when the vehicle seat is attached to the vehicle. In the following explanation, the description of directions will be based on these directions. Herein, the seat component 30 corresponds to “vehicle seat component” described in the scope of claims.

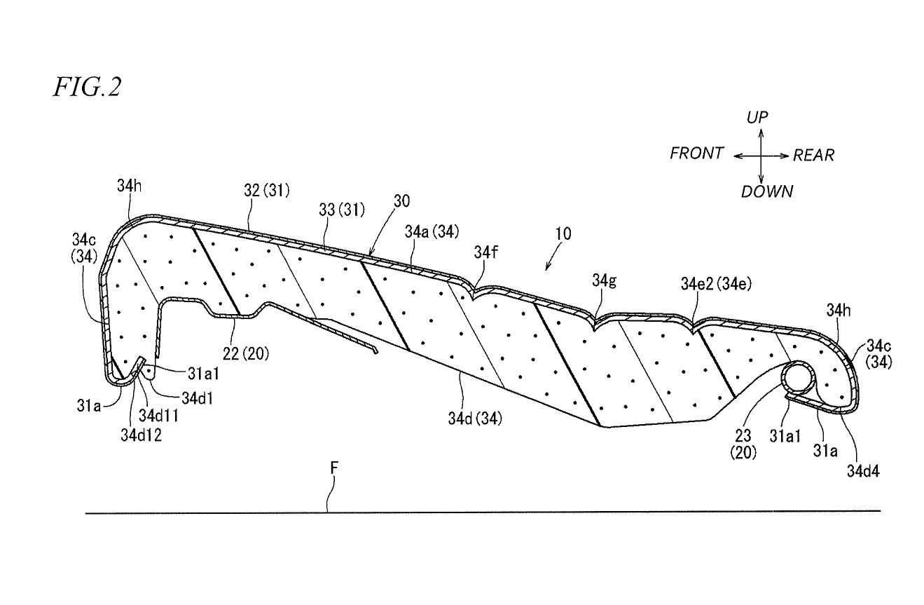

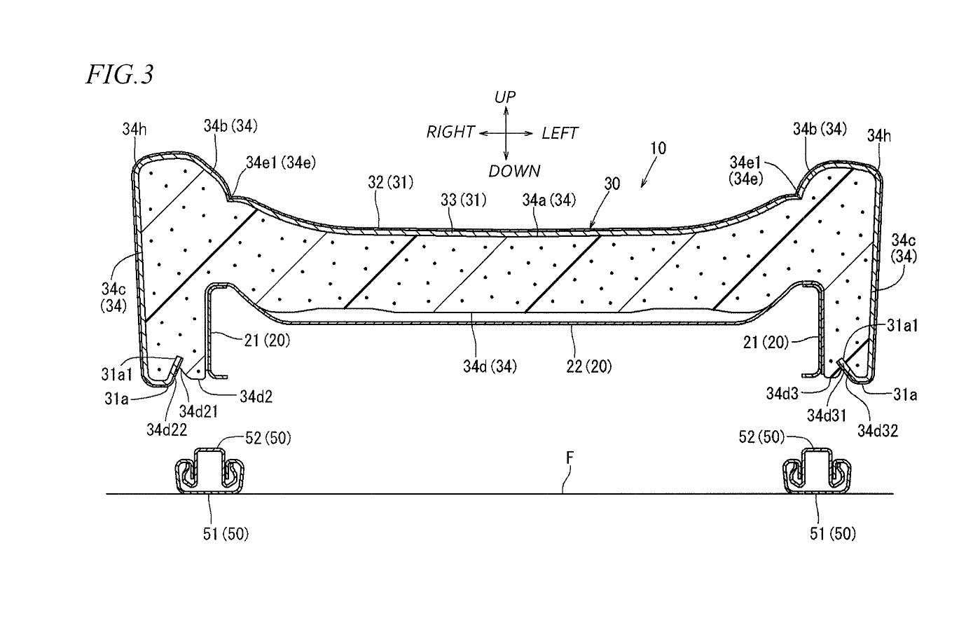

In general, the vehicle seat includes the seat cushion 10 which serves as a sitting portion, a seat back which serves as a backrest, and a headrest which supports a head. As illustrated in FIGS. 2 and 3, the seat cushion 10 includes a cushion frame 20 which forms a skeleton, and the seat component 30 which is mounted on the cushion frame 20. The cushion frame 20 connects, using a front panel 22, front parts of a pair of side frames 21 which are disposed to extend in a front and rear direction on the right and left sides of the seat cushion 10, and connects rear parts of the side frames using a rear pipe 23 so as to form almost a rectangular shape in top view. The pair of side frames 21 are respectively attached to slide rails 50 which extend in the front and rear direction to be provided on a floor F through a height adjusting mechanism (not illustrated). More specifically, the pair of side frames 21 are respectively attached to upper rails 52 through the height adjusting mechanism (not illustrated). The upper rails 52 are respectively slidably assembled in the front and rear direction to a lower rails 51 which extend in the front and rear direction and are fixed to the floor F. With this configuration, the cushion frame 20 is adjustable in position in the front and rear direction and the vertical direction with respect to the floor F.

As illustrated in FIGS. 1 to 3, the seat component 30 is formed in a state where a cushion cover 31 which is a cover material and a cushion pad 34 which is a cushion material are bonded in a planar fashion by integral foam-molding. The cushion cover 31 is formed such that a planar member formed by integrally stacking a cover pad 33 made of a foamed urethane slab on an outer cover 32 such as fabrics on the surface layer which is a sitting surface is cut into a plurality of parts to be integrally sewed along the outer shape of the cushion pad 34. The cushion pad 34 is a cushion body made of soft polyurethane foam. The cushion pad 34 includes a main seating portion 34a which supports lower surfaces of a hip part and a thigh part of a sitting occupant, banks 34b which support side surfaces of the hip part and the thigh part of the sitting occupant, an outer portion 34c which is a surrounding part in all directions, and a rear surface part 34d which abuts on the cushion frame 20. Three grooves having substantially V-shaped cross section are formed in the sitting surface of the cushion pad 34. A first groove 34e has substantially an inversed U shape opened forward in top view, and includes vertical grooves 34e1 which extend in the front and rear direction to face each other and a horizontal groove 34e2 which connects the rear ends of the vertical grooves 34e1 and extends in the right and left direction. The respective vertical grooves 34e1 are positioned between the main seating portion 34a and the right and left banks 34b, and the horizontal groove 34e2 is positioned in the rear end of a portion where a sitting pressure of the sitting occupant is applied. A second groove 34f is disposed at the center portion of the main seating portion 34a in the front and rear direction to extend in the right and left direction. A third groove 34g is disposed in the main seating portion 34a to be positioned between the horizontal groove 34e2 of the first groove 34e and the second groove 34f in the front and rear direction and extends in the right and left direction. The third groove 34g is formed to be slightly shorter compared to the second groove 34f. Herein, the cushion cover 31 and the cushion pad 34 respectively correspond to “seat cover” and “seat pad” described in the scope of claims. The main seating portion 34a and the bank 34b correspond to “seating portion” described in the scope of claims.

As illustrated in FIGS. 1 to 3, the seat component 30 is formed such that the cushion cover 31 is bonded in the planar fashion to the main seating portion 34a, the right and left banks 34b, and the outer portion 34c of the cushion pad 34. Specifically, in the surface on the opposite side to the outer cover 32 of the cover pad 33 of the cushion cover 31, part of a urethane material enters and is cured at the time of foam-molding the cushion pad 34, thereby forming a hard layer. The cushion cover 31 and the cushion pad 34 are bonded in the planar fashion with the hard layer. At the end of the cushion cover 31 in all directions, an extension part 31a is provided which extends downward from the outer portion 34c. Since the cushion cover 31 is bonded to the cushion pad 34 in the planar fashion at the outer portion 34c, there is a sense of tension in the cushion cover 31, and thus the appearance is good.

As illustrated in FIG. 2, the rear surface part 34d extending rearward from the lower end of the outer portion 34c of the front part is formed as a front-end rear surface part 34d1. The front-end rear surface part 34d1 is formed to be almost parallel to the main seating portion 34a between the lower end of the outer portion 34c of the front part and the front end of the front panel 22. A front groove 34d11 is provided almost at the center portion of the front-end rear surface part 34d1 in the front and rear direction, the front groove extending in the right and left direction and having the cross section of a substantially V shape opened downward. In a front wall surface 34d12 on the front side of the front groove 34d11, the tip end of the extension part 31a on the front side of the cushion cover 31 is bonded in the planar fashion by integral foam-molding. A tip end 31a1 of the extension part 31a on the front side is buried in the cushion pad 34. The rear surface part 34d extending forward from the lower end of the outer portion 34c of the rear part is formed as a rear-end rear surface part 34d4. The rear-end rear surface part 34d4 is formed to be almost parallel to the main seating portion 34a between the lower end of the outer portion 34c of the rear part and the rear end of the rear pipe 23. A groove having the cross section of a substantially V shape opened downward is not formed in the rear-end rear surface part 34d4. The extension part 31a on the rear side of the cushion cover 31 is not bonded to the rear-end rear surface part 34d4 by integral foam-molding. The tip end 31a1 of the extension part 31a on the rear side of the cushion cover 31 is attached to the rear pipe 23 by a mechanical means such as a hog ring after the seat component 30 is mounted on the cushion frame 20. Herein, the front groove 34d11 and the front wall surface 34d12 respectively correspond to “groove” and “wall surface” described in the scope of claims.

As illustrated in FIG. 3, the rear surface part 34d extending leftward from the lower end of the outer portion 34c on the right side is formed as a right-end rear surface part 34d2. The right-end rear surface part 34d2 is formed to be almost parallel to the main seating portion 34a between the lower end of the outer portion 34c on the right side and the right end of the right side frame 21. A right groove 34d21 is provided almost at the center portion in the right and left direction of the right-end rear surface part 34d2, the right groove extending in the front and rear direction and having the cross section of a substantially V shape opened downward. In a right wall surface 34d22 on the right side of the right groove 34d21, the tip end of the extension part 31a on the right side of the cushion cover 31 is bonded in the planar fashion by integral foam-molding. The tip end 31a1 of the extension part 31a on the right side is buried in the cushion pad 34. The rear surface part 34d extending rightward from the lower end of the outer portion 34c on the left side is formed as a left-end rear surface part 34d3. The left-end rear surface part 34d3 is formed to be almost parallel to the main seating portion 34a between the lower end of the outer portion 34c on the left side and the left end of the left side frame 21. A left groove 34d31 is provided almost at the center portion in the right and left direction of the left-end rear surface part 34d3, the left groove extending in the front and rear direction and having the cross section of a substantially V shape opened downward. In a left wall surface 34d32 on the left side of the left groove 34d31, the tip end of the extension part 31a on the left side of the cushion cover 31 is bonded in the planar fashion by integral foam-molding. The tip end 31a1 of the extension part 31a on the left side is buried in the cushion pad 34. Herein, the right groove 34d21 and the left groove 34d31 correspond to “groove” described in the scope of claims. The right wall surface 34d22 and the left wall surface 34d32 correspond to “wall surface” described in the scope of claims.

The tip end of the extension part 31a on the front side of the cushion cover 31 is bonded to and integrally formed with the front wall surface 34d12 on the front side of the front groove 34d11 by the integral foam-molding of the cushion pad 34. The tip end 31a1 of the extension part 31a on the front side is buried in the cushion pad 34 from the bottom of the front groove 34d11. Similarly, the tip end of the extension part 31a on the right side of the cushion cover 31 and the tip end of the extension part 31a on the left side are respectively bonded to and integrally formed with the right wall surface 34d22 on the right side of the right groove 34d21 and the left wall surface 34d32 on the left side of the left groove 34d31 by the integral foam-molding of the cushion pad 34. The tip end 31a 1 of the extension part 31a on the right side and the tip end 31a1 of the extension part 31a on the left side are respectively buried in the cushion pad 34 from the bottoms of the right groove 34d21 and the left groove 34d31. With this configuration, there is no need to fix the front right and left terminals of the cushion cover 31 to the rear surface part 34d of the cushion pad 34 by bonding, tacking, or the like. Accordingly, there is less concern that the terminal of the rear surface part 34d of the cushion pad 34 is deformed due to the pulling-in of the terminal of the cushion cover 31 so that appearance of the seat component 30 is impaired. Since the extension part 31a is fixed to the cushion pad 34 in the state of being folded from the rear surface part 34d of the cushion pad 34 toward the seating portion, there is less concern that the extension part abuts on other components, and the terminal of the cushion cover 31 is hardly peeled off.

Further, the tip end of the extension part 31a is integrally formed with the cushion pad 34 along the front wall surface 34d12 of the front groove 34d11, the right wall surface 34d22 of the right groove 34d21, and the left wall surface 34d32 of the left groove 34d31, the terminal of the extension part 31a is hardly visible, and thereby achieving good appearance. In addition, since the tip end 31a1 of the extension part 31a is formed to be buried in the cushion pad 34, there is no concern that the terminal of the cushion cover 31 abuts on other components and the terminal of the cushion cover 31 is more hardly peeled off.

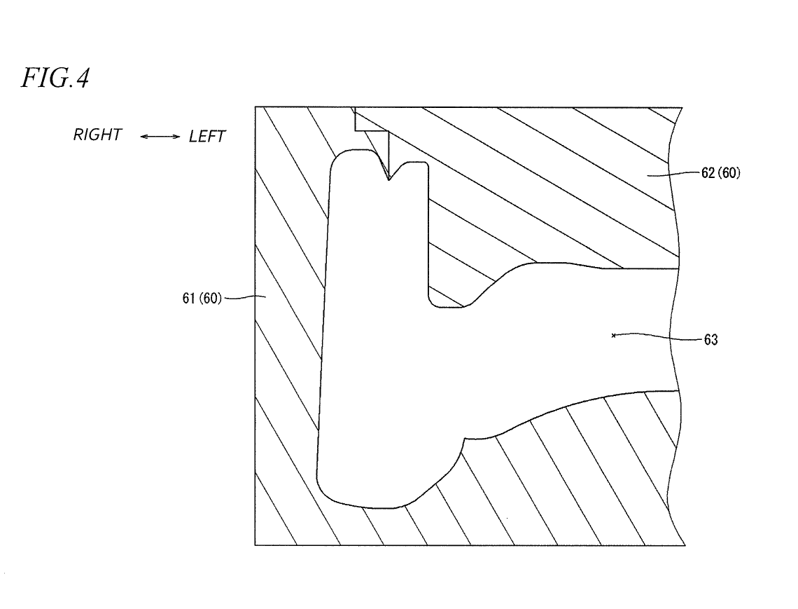

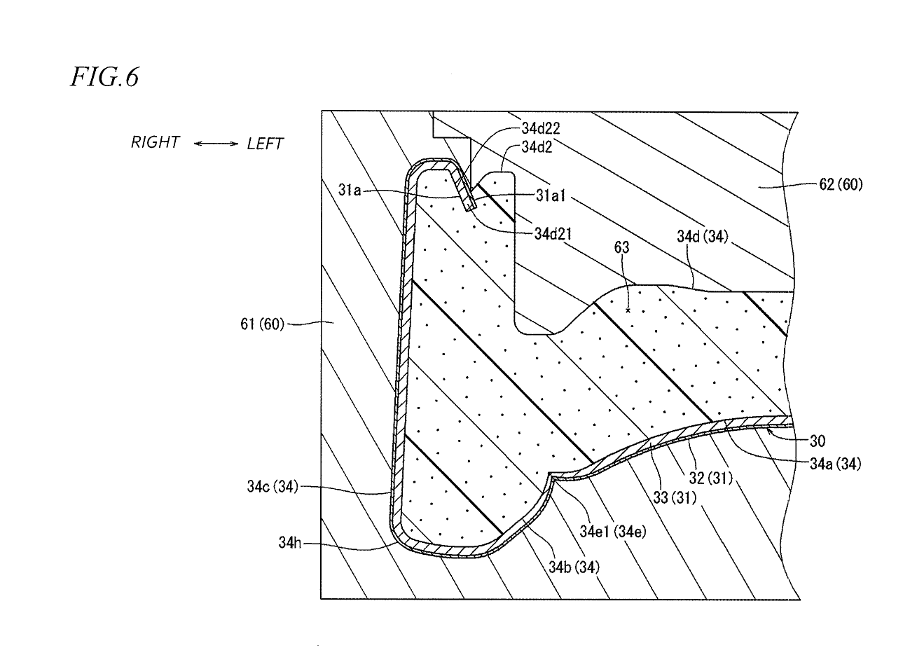

Next, a method of manufacturing the seat component 30 forming the seat cushion 10 will be described. As illustrated in FIGS. 4 to 6, a forming mold 60 includes a lower mold 61 and an upper mold 62 which are combined to form a cavity 63 in the superposed inside. A spatial shape of the cavity 63 is formed substantially to correspond to the shape of the cushion pad 34. Specially, the spatial shape of the cavity 63 is formed to correspond to the shape of the cushion pad 34 bonded to the cushion cover 31 in the planar fashion in the main seating portion 34a, the right and left banks 34b, and the outer portion 34c. The spatial shape of the cavity 63 of FIG. 6 is formed such that the seat component 30 illustrated in FIG. 3 is disposed to be inversed in the vertical direction. In other words, the upper surface of the lower mold 61 corresponds to the sitting surface of the cushion pad 34, and the lower surface side of the upper mold 62 corresponds to the rear surface which is a surface on the opposite side to the sitting surface of the cushion pad 34. In the forming mold 60, both the lower mold 61 and the upper mold 62 are formed of aluminum.

The lower mold 61 has the outer surface of the cavity 63 corresponding to the main seating portion 34a and the bank 34b of the cushion pad 34, the outer portion 34c, and a portion up to the right wall surface 34d22 of the right groove 34d21. As illustrated in FIG. 6, the structure of the right end of the lower mold 61 is described as a representative, but the left end of the lower mold 61 and the front end of the lower mold 61 also have the basically same structure. The cavity 63 is formed by covering the upper mold 62 from the upper side of the lower mold 61.

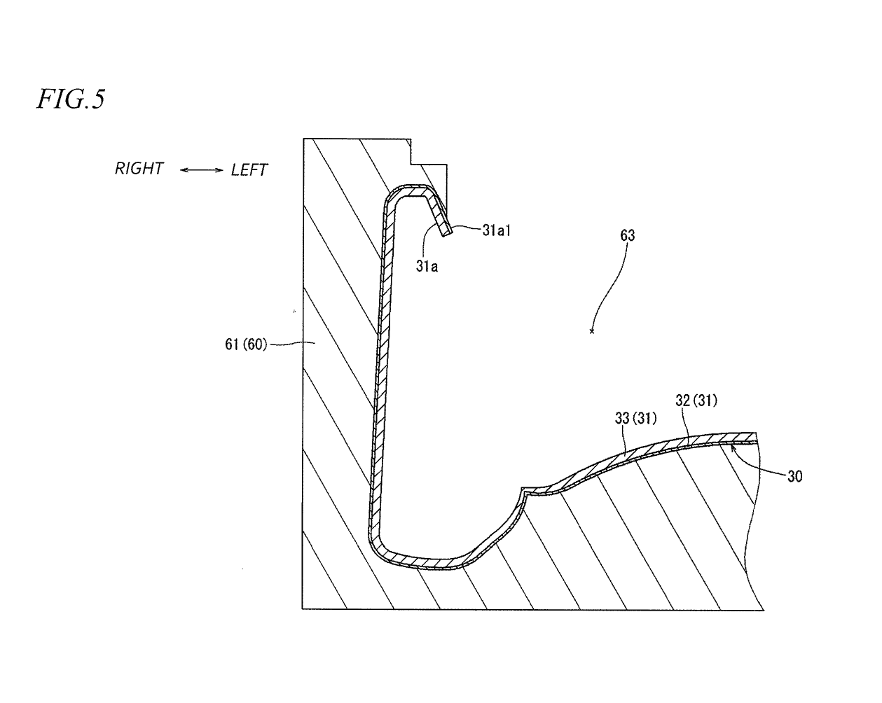

First, as illustrated in FIG. 5, the cushion cover 31 is set in the outer surface of the cavity 63 of the lower mold 61. Specifically, the cushion cover 31 is set with respect to the lower mold 61 such that the outer cover 32 abuts on the outer surface of the cavity 63 corresponding to the main seating portion 34a, the bank 34b, and the outer portion 34c of the cushion pad 34. Next, the extension part 31a on the right side of the cushion cover 31 is folded and abuts on the outer surface of the cavity 63 corresponding to the right wall surface 34d22 of the right groove 34d21 of the lower mold 61. In this state, the tip end 31a1 of the extension part 31a on the right side is separated from the outer surface of the cavity 63 corresponding to the right wall surface 34d22 and extends toward the left lower side. The cushion cover 31 is set in the basically similar way in the left end of the lower mold 61 and the front end of the lower mold 61. At the rear end of the lower mold 61, the extension part 31a on the rear side is mounted on a matching surface between the lower mold 61 and the upper mold 62. At this time, an engaging member such as Magic Tape (registered trademark) or a double-sided tape may be used as necessary such that the outer cover 32 abuts on the entire inner surface of the cavity 63.

In a state where the cushion cover 31 is set to the lower mold 61 as illustrated in FIG. 5, a urethane foam material is injected on the cover pad 33 of the cushion cover 31. As illustrated in FIG. 6, the upper mold 62 and the lower mold 61 are closed to foam and cure the urethane foam material. At this time, the upper mold 62 is engaged with the lower mold 61 such that the upper mold 62 and the lower mold 61 are closed in a state where the extension part 31a on the rear side is interposed between the matching surface and the lower mold 61 of the rear end part. At this time, the extension part 31a on the rear side of the cushion cover 31 is interposed and compressed between the matching surfaces of the upper mold 62 and the lower mold 61. Gas generated in the process of foaming and curing the urethane foam material is discharged to the outside of the cavity 63 through the cover pad 33 of the cushion cover 31, and accordingly part of the urethane foam material infiltrates into the front surface on a side near the cavity 63 of the cover pad 33 and is hardened. With this configuration, the cushion cover 31 and the cushion pad 34 are integrally bonded in the planar fashion in the main seating portion 34a, the right and left banks 34b, the outer portion 34c, and a portion from the boundary of the right-end rear surface part 34d2 with respect to the outer portion 34c to the right wall surface 34d22 of the right groove 34d21. The tip end 31a1 of the extension part 31a on the right side of the cushion cover 31 is integrally formed in the state of being cast into the cushion pad 34 on the extension of the right wall surface 34d22. The procedures at the left end of the lower mold 61 and the front end of the lower mold 61 are also similar basically. The forming mold 60 may be heated as needed while the urethane foam material is foamed and cured.

The cushion pad 34 integrally formed with the cushion cover 31 is removed from the forming mold 60 to obtain the seat component 30. Specifically, when the seat component 30 formed in the case illustrated in FIG. 6 is removed from the lower mold 61, the upper mold 62 is opened upward, and then part of the cushion pad 34 is pressed and deformed to release the engagement with the right-end rear surface part 34d2. With this configuration, it is possible to manufacture the seat component 30 with efficiency.

Hereinbefore, the specific embodiment has been described, but the present disclosure is not limited to the outer appearances and the configurations. Various changes, additions, and omissions may be made within a scope not departing from the spirit of the present disclosure. For example, the following configurations may be exemplified.

1. In the embodiment, the seat component 30 of the seat cushion 10 is described, but the present disclosure is not limited thereto. The configuration disclosed in the present disclosure may be applied to the seat back. In other words, the bonding structure of the end of the seat cover to the seat pad according to the present disclosure may be applied to the upper end and the right and left ends of the seat back. In a case where the configuration is applied to the seat back, the rear surface of the seat back is normally sealed by a member such as a backboard.

2. In the embodiment, the bonding structure of the end of the seat cover to the seat pad may be applied to the front end, the right end, and the left end of the seat cushion 10. However, the present disclosure is not limited to the above structure, and may be applied to any one or two of the front end, the right end, and the left end, or may be applied to the rear end.

3. In the embodiment, the cavity surface of the lower mold 61 is configured to correspond to the main seating portion 34a and the bank 34b of the cushion pad 34, the outer portion 34c, and a portion up to the right wall surface 34d22 of the right groove 34d21. However, the present disclosure is not limited to the above structure, and the cavity surface of the lower mold 61 may be configured to correspond to the main seating portion 34a and the bank 34b of the cushion pad 34, the outer portion 34c, and the entire right groove 34d21.

4. In the embodiment, the seat of a vehicle is described as an example, but the similar configuration may be applied to a seat of a railway vehicle, an airplane, a ship, or the like.

What is claimed is:

1. A vehicle seat component comprising:
a seat pad serving as a cushion material of a seat cushion or a seat back of a vehicle seat, the seat pad having a seating portion which receives a load of an occupant and an outer portion which surrounds the seating portion; and
a seat cover serving as an outer cover material being bonded to the seat pad in a planar fashion at the seating portion and the outer portion of the seat pad by integral foam-molding,
wherein at least a part of the seat cover at which the seat cover is bonded to the outer portion, is provided with an extension part that extends from an end of the outer portion at a side opposite to the seating portion,
wherein the outer portion is provided with a groove at a rear surface part of the seat pad, the groove extending along the end and having a bottom surface at a position closer to the seating portion with respect to the rear surface part, and
wherein at least a part of the extension part is integrally bonded to a wall surface of the groove by the integral foam-molding.

2. The vehicle seat component according to claim 1,
wherein the groove has a V-shaped cross section which is opened toward the side opposite to the seating portion.

3. The vehicle seat component according to claim 1,
wherein the extension part has a tip end being buried in the seat pad.

4. A method of manufacturing the vehicle seat component according to claim 1, the method comprising:
preparing a lower mold which has an inner surface corresponding to the seating portion, the outer portion, and the wall surface of the groove of the seat pad, and an upper mold which is matched with the lower mold to foam a cavity;
setting the seat cover to the lower mold such that a front surface of the seat cover abuts on an inner surface corresponding to the seating portion and the outer portion;
setting the extension part such that an outer surface thereof abuts on an inner surface corresponding to the wall surface;
injecting a urethane foam resin material into the cavity and closing the upper mold to foam and cure the urethane foam resin material; and
opening the upper mold to remove the vehicle seat component after the urethane foam resin material is foamed and cured.
